(19) United States
(12) Patent Application Publication
(10) Pub. No.: US 2023/0392273 A1
(43) Pub. Date: Dec. 7, 2023

(54) METHOD FOR MANUFACTURING RECYCLED ALUMINUM, MANUFACTURING EQUIPMENT, MANUFACTURING SYSTEM, RECYCLED ALUMINUM, AND PROCESSED ALUMINUM PRODUCT

(71) Applicant: Tohoku University, Sendai-shi, Miyagi (JP)

(72) Inventors: Tetsuya NAGASAKA, Sendai-shi (JP); Hongmin ZHU, Sendai-shi (JP); Takehito HIRAKI, Sendai-shi (JP); Xin LU, Sendai-shi (JP)

(73) Assignee: Tohoku University, Sendai-shi, Miyagi (JP)

(21) Appl. No.: 18/033,516

(22) PCT Filed: Oct. 28, 2021
(86) PCT No.: PCT/JP2021/039898

§ 371 Date: Apr. 24, 2023

(30) Foreign Application Priority Data
Oct. 28, 2020 (JP) 2020-180899

(51) Int. Cl. C25C 3/24; C25C 3/18

(52) U.S. Cl. CPC C25C 3/24; C25C 3/18

(57) ABSTRACT

A method for manufacturing recycled aluminum includes: disposing an aluminum alloy anode and a cathode in a facing manner in a molten salt, supplying a current between the aluminum alloy anode and the cathode at a temperature at which the aluminum alloy anode is in a solid state and the molten salt is in a liquid state to dissolve the aluminum alloy anode, and depositing an aluminum precipitate on the cathode.

### TECHNICAL FIELD

The present invention relates to a method for manufacturing recycled aluminum, a manufacturing apparatus of recycled aluminum, recycled aluminum manufactured by the manufacturing method or the manufacturing apparatus, a manufacturing system of recycled aluminum in which a plurality of manufacturing apparatuses of recycled aluminum are wired to serve as and operable as a single system, and a processed aluminum product obtained by processing recycled aluminum.

The present application claims priority based on Japanese Patent Application No. JP-A-2020-180899 filed on Oct. 28, 2020, and contents thereof are incorporated by reference.

### BACKGROUND ART

Aluminum is a typical metal material, and consumption of aluminum metal is about 1,800,000 tons in Japan and is 58,000,000 tons in the world (both for 2017), and is recognized together with iron and copper as three social infrastructure metal materials. As an industrial manufacturing method of aluminum, aluminum having a purity of about 99.7% to 99.98% is manufactured by a combination of the Bayer process and the Hall-Héroult process for a long time (primary electrolytic refining). The Bayer process is a method for manufacturing alumina by dissolving and extracting an alumina component in bauxite in caustic soda, and the Hall-Héroult process is a method for manufacturing aluminum by dissolving alumina in an electrolytic bath and electrolyzing alumina. Further, the Hall-Héroult process is a method in which alumina, which has a melting point of more than 2000° C., can be electrolyzed at an operating temperature of about 1000° C. Such electrolytic bath was found by Hall and Héroult about 120 years ago, and has been developed as an industrial manufacturing method of aluminum.

In order to obtain aluminum having a higher purity, two kinds of methods are industrially adopted. One is the trinal electrolytic process, and the other one is fractional crystallization. The trinal electrolytic process is a method similar to the Hall-Héroult process described above, and is a method in which primary electrolytic aluminum as a raw material is inserted into an alloy layer containing copper (Cu) and applied with electricity, thereby collecting only aluminum, which has a specific gravity lower than that of copper, on a cathode side located above. Therefore, high-purity aluminum having a purity of about 99.98% to 99.998% is manufactured.

As a specific example of the trinal electrolytic process, for example, Non-PTL 1 discloses a structure of an electrolytic refinement furnace, an electrolytic bath (mass %), an electrolysis temperature, and the like. Fractional crystallization is a method in which primary electrolytic aluminum as a raw material is dissolved and is locally cooled to crystallize and fractionate high-purity aluminum having a purity of about 99.98 to 99.996%.

However, except for copper as a conductive material (electrolytic copper: 99.99% purity), these three social infrastructure metal materials are rarely used as a pure metal, and in most cases, used in the form of an alloy also containing some other elements.

Compared with a steel product as an iron alloy, aluminum is high in degree of alloying, and as illustrated in FIG. 1, Cu, Si, Mg, Mn, and Fe are included, almost without exception, as alloy elements in a general-purpose aluminum product. In a case of a wrought material, an addition amount of these alloy elements is approximately 5%, sometimes about 15%. On the other hand, an alloy element concentration in a cast material is much higher than that of a wrought material, and the alloy element concentration is 10 to 25%.

Aluminum is recognized as a metal recycled well in terms of quantity, whereas in terms of quality (composition), the actual state of aluminum recycling is that accumulation of the alloy elements occurs more and downgrading of a secondary product progresses more as the number of times of recycling increases. Except for a few cases in which partial selection is performed to avoid mixing of a part of the elements, scrap sorting depending on standards or the like is not performed. That is, a used aluminum product, for example, an aluminum can, a construction material such as a sash, or an aluminum casting product, is collectively dissolved as scrap and is reused as secondary aluminum. However, components of the used aluminum product cannot be controlled, and thus the used aluminum product can be seldom used as a wrought material which has a stricter component specification, but is used for a casting product which is allowed to contain a large amount of alloy elements.

It is almost impossible to remove the alloy elements from aluminum, which is a kind of active metal, by using an existing dry type refining technique, and the alloy elements accumulate in aluminum. As typical alloy elements, only Mg shows a slight tendency towards oxidation, and removal of Cu, Si, Mn, and Fe by oxidation-volatilization removal cannot be expected. Common alloy elements that can be preferentially removed by chloridization include only Mg and some rare earth elements.

PTL 1 discloses a method of disposing molten aluminum containing an impurity on one side of a porous material that absorbs a molten salt electrolytic bath, using the aluminum containing an impurity as an anode, disposing a cathode on the other side of the porous material and supplying a direct current so as to refine aluminum.

### CITATION LIST

### Patent Literature

PTL 1: JPS58-93883A

### Non-Patent Literature

Non-PTL 1: Materia Japan, Volume 33, No. 1, 1994

### SUMMARY OF INVENTION

### Technical Problem

From the above, in the present situation where aluminum scrap containing various compositions is collectively dissolved without sorting in particular, recycled aluminum (secondary aluminum) melted from the scrap is only used for a cast material, die casting, or the like (hereinafter, may be referred to as “cast material”), which is a serious problem industrially. In other words, aluminum in the present situation is limited to be used for downgrade recycling.

In order to use a large amount of secondary aluminum alloy containing alloy elements in a high concentration, the only way is to prepare the secondary aluminum alloy by adding the alloy elements to a range satisfying a standard or to dilute the secondary aluminum alloy with a pure aluminum metal. However, if the pure aluminum metal is not used in an amount substantially equal to or more than the amount of the redissolved aluminum, the concentration of the alloy elements cannot be significantly reduced, and thus the dilution is not practical industrially. That is, in the present situation, it is extremely difficult to achieve horizontal recycling of aluminum, that is, so-called can-to-can.

With respect to such aluminum recycling, there is a high possibility that the demand for an aluminum cast material as a final sink of aluminum in the present situation is significantly reduced due to the EV shift, which is to proceed rapidly in the future. That is, when the demand for an aluminum material for casting used as an engine block for an automobile is reduced, the aluminum material for casting loses its utility. In the present situation, it is not easy to find a new major consumption field of the aluminum material for casting in place of the engine block, which has an overwhelming demand with respect to the aluminum material for casting. In the first place, the present situation of cascade-using aluminum, which is ridiculed as “canned electricity” and is an energy-intensive type resource, is a problem to be technically improved.

Therefore, as a result of concentrated studies, the inventors demonstrated that according to a purification method of reducing impurity elements from recycled aluminum (secondary aluminum) melted from an aluminum cast material scrap by using a molten salt electrolysis unit for supplying a current between an alloy anode made of the regenerated aluminum and a cathode at a temperature at which the recycled aluminum (secondary aluminum) is in a solid state and a molten salt is in a liquid state, alloy elements can be removed from the aluminum cast material scrap and the aluminum cast material scrap can be recycled and recovered as high-purity aluminum.

Not only can-to-can horizontal recycling, which is impossible in the present situation, but also upgrade recycling from the cast material to the wrought material is possible. A large impact to the industry is provided by the upgrade recycling, and even if the demand for the cast material is drastically reduced, the wrought material can be produced in Japan without importing new aluminum metal from overseas.

The invention has been made in view of the circumstances described above, and an object of the invention is to provide a method for manufacturing recycled aluminum, a manufacturing apparatus of recycled aluminum, a manufacturing system of recycled aluminum, recycled aluminum, and a processed aluminum product, by which a concentration of contained alloy elements is significantly reduced as compared with the original aluminum alloy material.

Regarding the “method for manufacturing recycled aluminum”, in the description, such a method by which the alloy elements can be removed from a recycled aluminum (secondary aluminum) melted from aluminum cast material scrap and the aluminum cast material scrap can be recycled and recovered as high-purity aluminum is abbreviated as a “method for manufacturing recycled aluminum”. That is, in the description, the “recycled aluminum” means “aluminum recycled with a high purity” from “recycled aluminum (secondary aluminum)”, in which the alloy element concentration is significantly reduced, and an aluminum alloy melted from the original aluminum cast material scrap (recycled aluminum (secondary aluminum)) is described as “aluminum alloy” to distinguish each other.

### Solution to Problem

In order to solve the above problems, the disclosure provides the following aspects.

(1) A method for manufacturing recycled aluminum according to a first aspect of the invention includes: disposing an aluminum alloy anode and a cathode in a molten salt in a facing manner; supplying a current between the aluminum alloy anode and the cathode at a temperature at which the aluminum alloy anode is in a solid state and the molten salt is in a liquid state to ionize and elute aluminum from the aluminum alloy anode; and depositing an aluminum precipitate on the cathode.

(2) In the method for manufacturing recycled aluminum according to the above aspect, the aluminum alloy anode and the cathode may have a flat plate shape, and the flat plate-shaped aluminum alloy anode and the flat plate-shaped cathode may be disposed in a facing manner, or alternatively, the cathode may have a rod shape, and a plate-shaped aluminum alloy anode disposed concentrically around the rod-shaped cathode may face the cathode.

(3) The method for manufacturing recycled aluminum according to the above aspect may further include precipitating anode mud (anode slime) containing an impurity element that is not ionized from the aluminum alloy anode.

(4) In the method for manufacturing recycled aluminum according to the above aspect, the aluminum alloy anode may be manufactured by a method including an anode producing step of dissolving an aluminum alloy scrap to produce an anode.

(5) In the method for manufacturing recycled aluminum according to the above aspect, a conductivity of the molten salt may be 1 S m⁻¹ or more.

(6) In the method for manufacturing recycled aluminum according to the above aspect, the temperature may be room temperature or higher and 660° C. or lower.

(7) In the method for manufacturing recycled aluminum according to the above aspect, the molten salt may contain AlF₃ in an amount of 1.5 mass % to 35 mass %.

(8) The method for manufacturing recycled aluminum according to the above aspect may further include taking out the precipitated anode mud.

(9) In the method for manufacturing recycled aluminum according to the above aspect, a direction in which the aluminum alloy anode and the cathode are disposed in a facing manner may be substantially the same as a direction of gravity.

(10) A manufacturing apparatus of recycled aluminum according to a second aspect of the invention includes a unit configured to dispose an aluminum alloy anode and a cathode in a facing manner in a molten salt, and supply a current between the aluminum alloy anode and the cathode at a temperature at which the aluminum alloy anode is in a solid state and the molten salt is in a liquid state, in which the manufacturing apparatus of recycled aluminum is configured to ionize aluminum from the aluminum alloy anode and deposit aluminum on the cathode, and is configured to precipitate anode mud (anode slime) containing an impurity element which is not ionized from the aluminum alloy anode.

(11) In the manufacturing apparatus of recycled aluminum according to the above aspect, a plurality of anodes and cathodes in which the aluminum alloy anode and the cathode are disposed in a facing manner are disposed in the molten salt.

(12) The manufacturing apparatus of recycled aluminum according to the above aspect may further include a unit configured to wire the plurality of anodes and cathodes in which the aluminum alloy anode and the cathode are disposed in a facing manner, and supply a current thereto in parallel or in series.

(13) A manufacturing system of recycled aluminum according to a third aspect of the invention is operable by wiring a plurality of the manufacturing apparatuses of recycled aluminum serving as a single system.

(14) Recycled aluminum according to a fourth aspect of the invention is manufactured by the method for manufacturing recycled aluminum.

(15) The recycled aluminum according to the above aspect may have a concentration of Si of 0.001 mass % or more and 1 mass % or less, and a concentration of Cu of 0.001 mass % or more and 0.5 mass % or less.

(16) A processed aluminum product according to a fifth aspect of the invention is obtained by processing the recycled aluminum.

(17) An anode slime according to a sixth aspect of the invention is obtained by manufacturing recycled aluminum using the method for manufacturing recycled aluminum.

### Advantageous Effects of Invention

According to the method for manufacturing recycled aluminum of the invention, it is possible to manufacture recycled aluminum having a high aluminum purity by using an aluminum alloy material such as an aluminum cast material scrap at a low energy consumption, and the concentration of the alloy elements in the recycled aluminum is significantly reduced.

### BRIEF DESCRIPTION OF DRAWINGS

FIG. 1 is an example of a manufacturing process flow diagram illustrating a flow of a method (steps) for manufacturing recycled aluminum according to an embodiment of the invention.

FIG. 2 is an SEM image of a cross section of an aluminum alloy anode after a solid electrolysis step.

FIG. 3 is an example of a schematic vertical cross-sectional view of a solid electrolysis device to which a current is supplied according to a method for manufacturing recycled aluminum.

FIG. 4 is an example of a schematic vertical cross-sectional view illustrating another example of the solid electrolysis device to which a current is supplied according to the method for manufacturing recycled aluminum.

FIG. 5 is an example of a schematic vertical cross-sectional view illustrating still another example of the solid electrolysis device to which a current is supplied according to the method for manufacturing recycled aluminum.

FIG. 6 is an example of a schematic vertical cross-sectional view illustrating a configuration of the solid electrolysis device to which a current is supplied according to the method for manufacturing recycled aluminum, the solid electrolysis device including plate-shaped aluminum alloy anodes disposed concentrically around a rod-shaped cathode and facing the cathode.

(a) of FIG. 7 is an example of a graph illustrating results of composition concentration analysis (Al, Si, and Cu) with respect to the aluminum alloy anode used as a raw material, anode mud (anode slime) as a by-product generated due to the current supply, and aluminum deposited on a cathode side due to the current supply in the method for manufacturing recycled aluminum according to the embodiment of the invention; (b) of FIG. 7 is a photograph of the aluminum alloy anode as a raw material; (c) of FIG. 7 is a photograph of an aluminum precipitate separated from the cathode; (d) of FIG. 7 is an example of a photograph of recycled aluminum obtained by redissolving the aluminum precipitate; and (e) of FIG. 7 is an example of a photograph of the anode slime.

FIG. 8 is an example of a graph illustrating a result of XRD analysis with respect to the anode slime.

FIG. 9 is an example of a schematic vertical cross-sectional view illustrating further another example of the solid electrolysis device to which a current is supplied according to the method for manufacturing recycled aluminum.

FIG. 10 illustrates a cyclic voltammogram waveform (CV waveform) of the aluminum deposited on the cathode in Example 1.

### DESCRIPTION OF EMBODIMENTS

Hereinafter, one or more embodiments of the invention will be described with reference to the drawings. In the following embodiments, the same or equivalent parts may be denoted by the same reference numerals in the drawings. In the drawings used in the following description, in order to make the features easier to understand, the features may be enlarged for convenience, and the dimensional ratios of the constituent elements may not be the same as the actual ones. Furthermore, the materials, dimensions, and the like exemplified in the following description are examples, and the invention is not limited thereto and can be carried out with appropriate modifications within a range in which the above-described effects of the invention are achieved. The configuration described in one embodiment can also be applied to other embodiments.

### [Method for Manufacturing Recycled Aluminum]

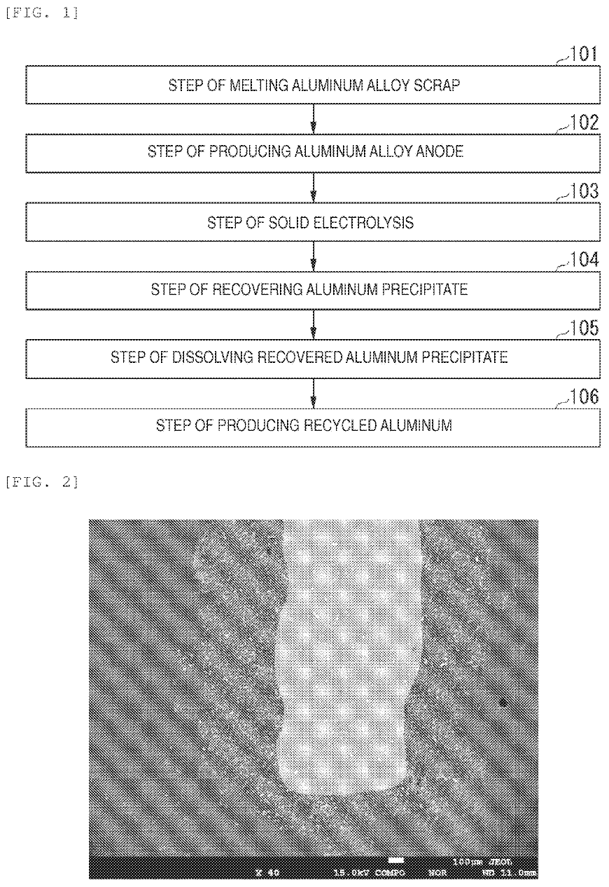

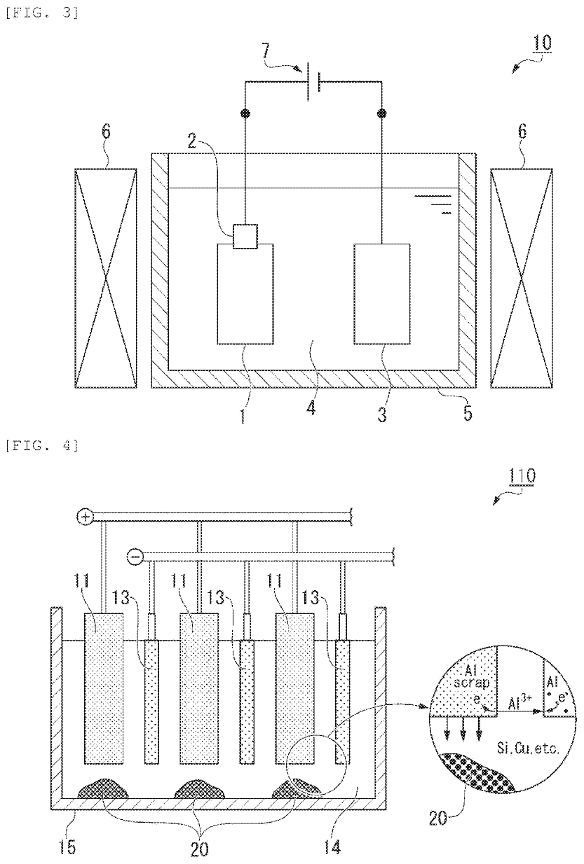

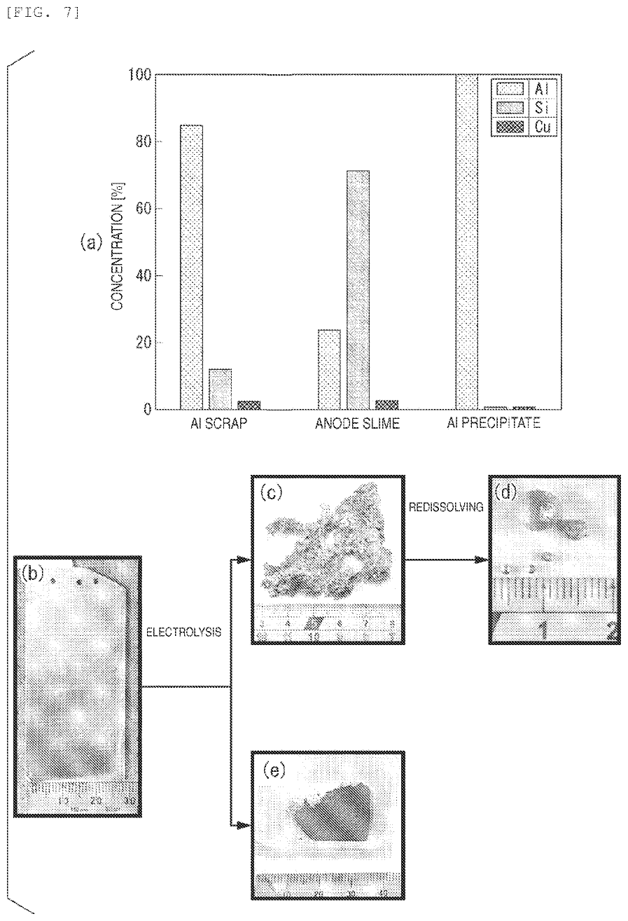

FIG. 1 is a manufacturing process flow diagram illustrating a flow of manufacturing steps included in an example of a method for manufacturing recycled aluminum according to an embodiment of the invention. FIG. 3 is a schematic vertical cross-sectional view illustrating an example of a solid electrolysis device for carrying out a solid electrolysis step of the method for manufacturing recycled aluminum.

In the description, the term “recycled aluminum” is not limited to high-purity aluminum generally called pure aluminum (purity: about 99.98% to 99.998%), and includes all recycled aluminum containing alloy elements (impurity elements) that is recycled from an aluminum scrap containing various compositions as a raw material while reducing the alloy elements by using the method according to the invention. A shape of the “recycled aluminum” is not limited, for example, an ingot, a plate material, a bar material, a foil material, an amorphous mass, fine particles or the like which are made of the recycled aluminum is included in the “recycled aluminum”. Further, the term “recycled” means that the concentration of the alloy elements is lower than that of an original aluminum alloy material.

The method for manufacturing recycled aluminum according to the invention is a method for manufacturing recycled aluminum in which aluminum having a higher purity is recycled from an aluminum alloy anode, which is formed from the aluminum scrap as a raw material, by removing alloy elements contained in an aluminum alloy using the method for manufacturing recycled aluminum of the invention.

For example, when a product obtained by melting an aluminum cast material scrap and processing the melt into an anode shape is used as the aluminum alloy anode, the product can be recycled to an aluminum cast material, an aluminum wrought material or the like having a reduced containing concentration of contained alloy elements as compared with that of the original aluminum cast material scrap.

Hereinafter, the manufacturing steps in a case where the method for manufacturing recycled aluminum according to the invention includes a step of producing an aluminum alloy anode will be described with reference to FIGS. 1 and 3.

### <Step of Dissolving Aluminum Alloy Scrap>

As illustrated in FIG. 1, step 101 of melting an aluminum alloy scrap is performed as necessary in the production of the aluminum alloy anode, and can be freely performed by a known method for dissolving an aluminum alloy.

In the method for manufacturing recycled aluminum according to the invention, in a case where the aluminum alloy material as a raw material to be recycled can be used as an anode as it is, step 101 is not an essential step.

In the description, examples of the term “aluminum alloy scrap” typically include a scrap of a used aluminum product but are not limited thereto, and all scraps of aluminum alloys to be recycled are included. The “aluminum alloy scrap” to be dissolved may be one or more.

Examples of the “aluminum alloy scrap” include a scrap of a cast material, a scrap of a wrought material, and mixed scraps of the cast material and the wrought material.

Examples of the alloy elements (impurity elements) contained in the “aluminum alloy scrap” include 50 or more kinds of elements defined in JIS standard, and typical examples thereof include Mg, Cu, Si, Fe, Zn, and Mn. A case where an aluminum alloy having a high purity is recycled by the method for manufacturing recycled aluminum according to the invention means that one or more of these alloy elements are reduced in concentration.

The concentration of the alloy elements contained in the “aluminum alloy scrap” is not limited in principle, and for example, the concentration is 30% or less when a scrap of a used aluminum product is used. In the description, the “concentration” or the “purity” of the alloy elements or aluminum means mass % unless otherwise specified.

For example, when a scrap of a cast material specified in JIS standard other than Al—Si—Cu—Mg—Ni alloys is used as the “aluminum alloy scrap”, a concentration of alloy elements contained therein is 20% or less.

In addition, for example, when a scrap of a wrought material specified in JIS standard other than 4000 series is used as the “aluminum alloy scrap”, a concentration of alloy elements contained therein is 10% or less.

### <Step of Producing Aluminum Alloy Anode>

Step 102 of producing an aluminum alloy anode typically includes processing into the shape of the anode (for example, processing into a plate shape), and further includes all steps performed for producing the aluminum alloy anode. In the method for manufacturing recycled aluminum according to the invention, in the case where the aluminum alloy material to be recycled can be used as an anode as it is, step 102 is not an essential step.

### <Solid Electrolysis Step>

Step 103 of solid electrolysis is a step in which an aluminum alloy anode and a cathode are disposed in a facing manner in a molten salt, a current is supplied between the aluminum alloy anode and the cathode at a temperature at which the aluminum alloy anode is in a solid state and the molten salt is in a liquid state to dissolve the aluminum alloy anode. At this time, an aluminum precipitate is deposited on the cathode.

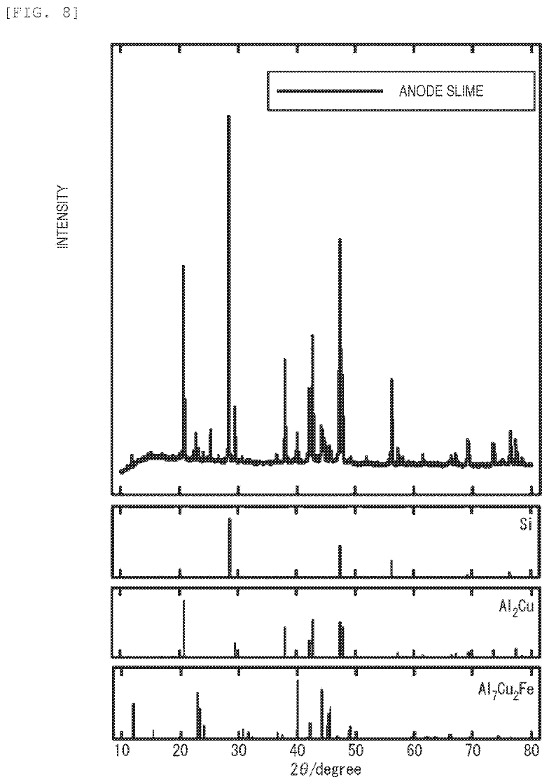

Here, examples of a configuration in which “an aluminum alloy anode and a cathode are disposed in a facing manner” include, for example, a configuration in which flat plate-shaped aluminum alloy anodes and flat plate-shaped cathodes are disposed in a facing manner (such as FIG. 4) or a configuration in which plate-shaped aluminum alloy anodes are concentrically disposed around a rod-shaped cathode in a facing manner may be exemplified. In addition to these configurations, a known configuration commonly used in electrolysis may be used.

In the case where the flat plate-shaped aluminum alloy anodes and the flat plate-shaped cathodes are disposed in a facing manner, it is preferable that the aluminum alloy anodes and the cathodes are substantially disposed in parallel in a facing manner. Since a distance between the electrodes is constant with respect to entire surfaces of the electrodes because the electrodes are substantially parallel to each other, the removal of aluminum ions from a surface of the aluminum alloy anode becomes uniform.

In the description, the term “solid electrolysis” means the aluminum alloy anode is electrolyzed in a solid state.

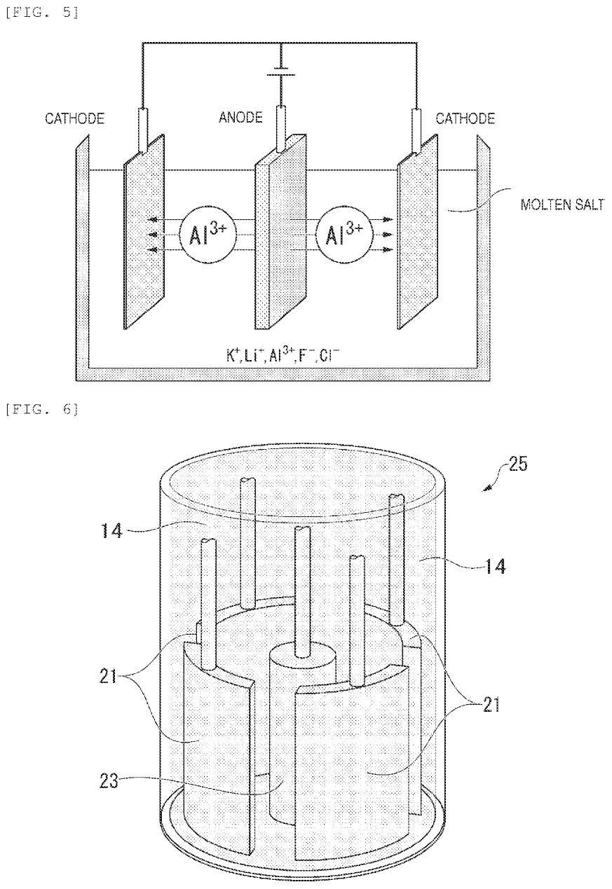

FIG. 2 illustrates an SEM image of a cross section of the aluminum alloy anode after the solid electrolysis step. The SEM image is obtained at an accelerating voltage of 15 kV by FE-SEM (JXA-8530F (manufactured by JEOL Ltd.)). In an electrolytic bath in which an aluminum casting alloy AC2A was used as the aluminum alloy anode, a pure aluminum plate was used as the cathode, and an anodic current density was set to 200 mA cm⁻² as electric field conditions, LiCl—KCl-5 mol % AlF₃ at 500° C. was electrolyzed for 2 hours.

From the SEM image, it can be seen that a surface side of the aluminum alloy anode has a porous structure.

In addition, results of composition analysis (ICP-AES) with respect to the aluminum alloy anode before the electrolysis and the porous structure after the electrolysis are shown in Table 1. It can be seen that in the porous structure after the electrolysis, a ratio of Al is significantly decreased. From the SEM image and the results of the composition analysis, it is considered that the porous structure formed on the surface side of the aluminum alloy anode is caused by the aluminum ions being removed from the surface of the aluminum alloy anode in the solid state. In addition, in the porous structure after the electrolysis, concentrations of impurities such as Si and Cu are significantly increased. Therefore, it is shown that the impurities such as Si and Cu are main elements constituting a skeleton of the porous structure. It is considered that this is because the concentrations of Si and Cu before the electrolysis are high to a certain extent as 5.1% and 3.8%, respectively. It is considered that since the original concentrations of these impurities are high, the impurities become the main elements constituting the skeleton of the porous structure.

TABLE 1

| | Al | Si | Cu | Others |
|---|---|---|---|---|
| Before electrolysis | 90.2 | 5.1 | 3.8 | 1.0 |
| After electrolysis | 31.5 | 41.2 | 23.2 | 4.1 |

In this step, the aluminum precipitate is deposited on the cathode during the solid electrolysis, and thus this step can be said to be a solid electrolysis and precipitate deposition step.

In addition, during the solid electrolysis, the impurity elements in the aluminum alloy anode may precipitate as anode mud (slime) depending on the concentrations thereof and the like. As described above, when the concentrations of the impurities are high to a certain extent, the impurity elements remain in the porous structure on the surface side, and a part of the porous structure may drop to form the slime, or may precipitate as the slime as known in copper electrolysis when the concentrations of the impurities are low. Regarding precipitating separation of the anode mud, since the anode mud is precipitated in the direction of gravity of the aluminum alloy anode and the cathode, the anode mud can be easily separated and taken out. Therefore, the direction in which the aluminum alloy anode and the cathode are disposed in a facing manner is substantially the same as the direction of gravity.

FIG. 3 is a schematic vertical cross-sectional view of an example of the solid electrolysis device included in a manufacturing apparatus of recycled aluminum according to the embodiment of the invention.

In the method for manufacturing recycled aluminum illustrated in FIG. 3, a solid electrolysis device 10 for carrying out the solid electrolysis step includes an anode holder 2 that holds an aluminum alloy anode 1, a cathode 3, an electrolytic cell 5 that accommodates a molten salt 4, a heating device 6 that can maintain a temperature at which the aluminum alloy anode 1 is in a solid state and the molten salt 4 is in a liquid state, and a power supply 7 that supplies current between the aluminum alloy anode 1 and the cathode 3.

During the solid electrolysis step, the aluminum alloy anode 1 is attached to the anode holder 2, and the molten salt 4 is added to the electrolytic cell 5.

As the molten salt, a chloride-based molten salt, a fluoride-based molten salt, a bromide-based molten salt, a mixed salt thereof, or the like can be used. As the chloride-based molten salt, for example, KCl, NaCl, CaCl₂, LiCl, RbCl, CsCl, SrCl₂, BaCl₂, MgCl₂, and a mixed salt thereof can be used. As the fluoride-based molten salt, for example, LiF, NaF, KF, RbF, CsF, MgF₂, CaF₂, SrF₂, BaF₂, AlF₃, and a mixed salt thereof can be used. In the case of fluoride-based molten salt, AlF₃ is preferably contained in the molten salt. For example, AlF₃ is preferably contained in a range of 1.5 mass % to 35 mass %, more preferably in a range of 3 mass % to 25 mass %, and still more preferably in a range of 6 mass % to 15 mass % in the molten salt.

Further, AlF₃ is preferably contained in a range of 1 mol % to 28 mol %, more preferably in a range of 2 mol % to 14 mol %, and still more preferably in a range of 4 mol % to 10 mol % in the molten salt.

From the viewpoint of lowering a melting point, it is effective to positively cause the molten salt to contain an aluminum halide. Examples of the aluminum halide include aluminum fluoride (AlF₃), aluminum chloride (AlCl₃), and aluminum bromide (AlBr₃). From the viewpoint of reducing a change in the compositions of the electrolytic bath due to evaporation, or from the viewpoint of easy continuous electrolysis, aluminum fluoride is preferably used rather than aluminum chloride. In a case of using aluminum chloride, it is necessary to perform electrolysis in a sealed environment because a vapor pressure at an electrolysis temperature is high, whereas in a case of using aluminum fluoride, the vapor pressure of the electrolytic bath decreases, and continuous electrolysis can be performed even in an open environment.

In addition, the molten salt may contain other components as inevitable impurities or may intentionally contain other components within a range in which the effects of the invention are achieved. In particular, the aluminum alloy scrap usually contains the element Mg, and therefore, Mg is mixed into the molten salt in the solid electrolysis step. For example, when a chloride-based molten salt such as LiCl—KCl eutectic salt (Examples) or NaCl—KCl is used, an MgCl₂-based eutectic salt such as MgCl₂—LiCl—KCl or MgCl₂—NaCl—KCl may be obtained, and the effects of the invention are achieved in this case as well. Therefore, an MgCl₂—NaCl—KCl-based molten salt, which is inexpensive, can be preferably used as the chloride-based molten salt. The MgCl₂—NaCl—KCl-based molten salt is suitable because it is possible to adjust an applicable temperature range of the molten salt by adjusting the components. For example, it is suitable that MgCl₂ is contained in a range of 1 mass % to 70 mass %, preferably in a range of 10 mass % to 60 mass %, and more preferably in a range of 20 mass % to 50 mass % in the MgCl₂—NaCl—KCl-based molten salt.

In the invention, an ionic liquid containing a known organic aluminum compound can be used as the molten salt. Specific examples of such an organic aluminum compound include an ionic liquid containing aluminum chloride (AlCl₃) and 1-ethyl-3-methylimidazolium chloride ([EtMeIm]Cl) (Keikinzoku, Vol. 69, No. 1 (2019), 15-21).

A density of the molten salt is preferably as small as possible in order to facilitate the precipitating separation of alloy components such as Cu or Si as the slime from the aluminum alloy anode.

From this viewpoint, a molten salt having a density equal to or lower than a density of pure aluminum (2.70 g/cm³ near room temperature and 2.375 g/cm³ near the melting point (660° C.)) can be used.

From the viewpoint of reduction in energy consumption and productivity of recycled aluminum, a molten salt having a conductivity of 1 S m⁻¹ or more is preferably used, a molten salt having a conductivity of 10 S m⁻¹ or more is more preferably used, and a molten salt having a conductivity of 100 S m⁻¹ or more is still more preferably used. When the conductivity of the molten salt is less than 1 S m⁻¹, current-supplying efficiency of electrolytic oxidation is low, and the productivity of recycled aluminum is lowered.

An upper limit of the conductivity at which a molten salt can be used can be set to 500 S m⁻¹ or less. This is because a substance having a conductivity exceeding 500 S m⁻¹ is metal-based, and cannot be used as a molten salt.

For example, a conductivity of the LiCl—KCl eutectic salt shown in Examples is 187 S m⁻¹ (500° C.).

As the cathode, aluminum or an aluminum alloy can be used. The invention is not limited thereto, and any electrode material may be used as the cathode as long as aluminum to be deposited can be separated, for example, stainless steel, carbon, nickel, iron, or the like can be used.

The temperature for the execution of the solid electrolysis step is a temperature at which the aluminum alloy anode is in the solid state and the molten salt is in the liquid state. Specifically, for example, a temperature in a range of room temperature or higher and 660° C. or lower can be set. The temperature for the execution of the solid electrolysis step is preferably in a range of 150° C. to 600° C., more preferably in a range of 300° C. to 550° C., and still more preferably in a range of 450° C. to 550° C.

Since the melting point of pure aluminum is 660° C., and the melting point decreases when the alloy components are added, the temperature does not exceed 660° C. For example, when Si is added to pure aluminum at a concentration of 10%, the melting point decreases to about 570° C.

The phrase “the molten salt is in a liquid state” can be translated as a phrase that the molten salt is in a molten state.

FIGS. 4, 6, and 9 are schematic vertical cross-sectional views illustrating other examples of the solid electrolysis device for carrying out the solid electrolysis step of the method for manufacturing recycled aluminum. FIGS. 4 and 9 also describe diagrams, characters, and symbols for conceptually explaining a phenomenon occurring during the solid electrolysis step.

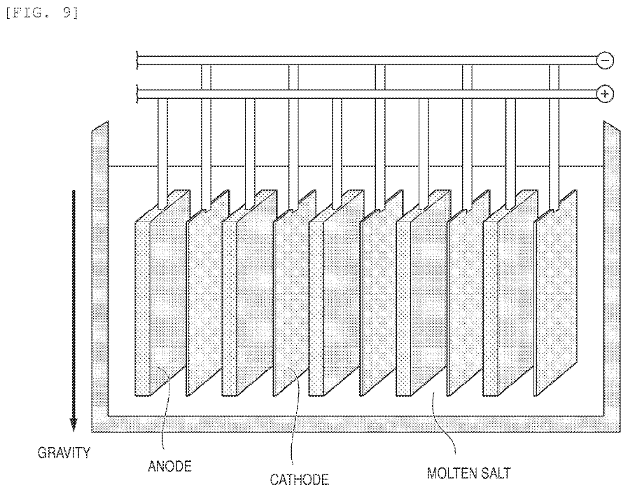

According to the examples of the solid electrolysis device illustrated in FIGS. 4 and 5, in a molten salt 14 inside an electrolytic cell 15, aluminum alloy anodes 11 and cathodes 13 are alternately arranged to be parallel to each other in a facing manner. That is, in the molten salt, a plurality of sets (pairs) of anodes and cathodes, in which the aluminum alloy anodes 11 and the cathodes 13 face each other, are disposed. In addition, the anodes and the cathodes are not necessarily paired with each other (FIG. 5), and may face each other and be disposed alternately. In FIG. 4, a symbol 20 denotes the anode slime, and a case where the anode slime is precipitated is illustrated as an example. FIG. 4 illustrates an enlarged view of a portion where the aluminum alloy anodes 11, the cathodes 13, and the anode slime 20 are close to each other, which is indicated by a circle. A basket for collecting the anode slime dropping from the aluminum alloy anodes 11 may be provided below the aluminum alloy anodes 11.

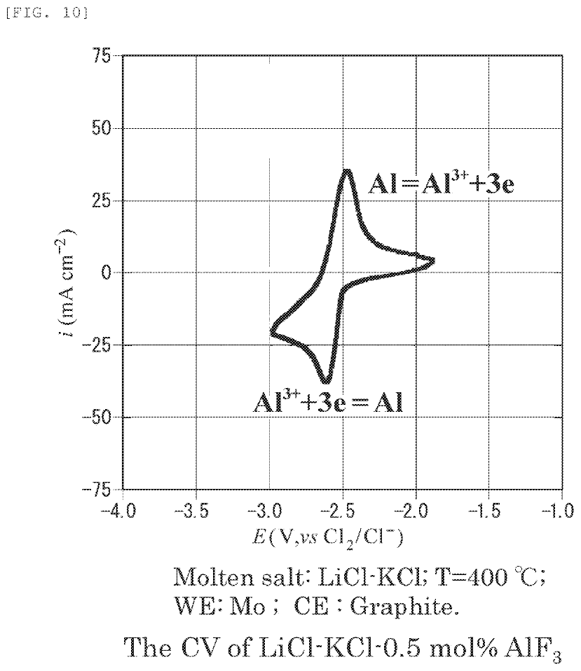

In the example of the solid electrolysis device illustrated in FIG. 6, a configuration is illustrated in which, in the molten salt 14 inside a cylindrical electrolytic cell 25, four plate-shaped aluminum alloy anodes 21 arranged concentrically are arranged around a rod-shaped cathode 23 and face the cathode 23. Each of the plate-shaped aluminum alloy anodes 21 is disposed in an arc shape when viewed from above. In the example illustrated in FIG. 6, the number of plate-shaped aluminum alloy anodes 21 is not limited to four, and may be two, six, eight, or the like. In addition, the aluminum alloy anodes 21 may form a single cylindrical shape that is continuously connected.

Further, it is unnecessary for each of the plate-shaped aluminum alloy anodes 21 to be arranged in the arc shape when viewed from above, and the plate-shaped aluminum alloy anodes 21 may be four flat plates arranged in a square shape, or six flat plates arranged in a regular hexagon shape, or eight flat plates arranged in a regular octagon shape, or the like.

In the solid electrolysis device according to the invention, a known porous material (having a function of a separator) having a porous structure through which molten salt ions can pass may be used between the aluminum alloy anodes 11 and the cathodes 13 as necessary. Examples of the porous material include, but are not limited to, glass cloth and a molded article of ceramic fiber having a large alumina content.

In the solid electrolysis step, when a current is flowed between the aluminum alloy anodes 11 and the cathodes 13, aluminum is dissolved on surfaces of the aluminum alloy anodes 11 to become aluminum Al³⁺, and then moves to and is deposited on surfaces of the cathodes 13. At the same time, the alloy components such as Cu and Si contained in the aluminum alloy anodes 11 are precipitated and separated as the slime.

Such a solid electrolysis device may be a large-sized device (system) provided with a unit for supplying a current in parallel or in series to each of the plurality of sets (pairs) of anodes and cathodes in which the aluminum alloy anodes and the cathodes face each other.

It is desirable that a current density is large from the viewpoint of increasing an aluminum deposition rate to improve the productivity. For example, the current density can be set to 5 mA/cm² to 2000 mA/cm². In the invention, since there is no problem in a formation state of the deposited aluminum (for example, non-uniformity in an aluminum film, dendrite formation, and the like), the current density can be determined from the viewpoint of production efficiency.

The current flowing between the aluminum alloy anodes 11 and the cathodes 13 can be a constant current. As the solid electrolysis progresses, as illustrated in FIG. 2, the aluminum alloy anodes become the porous structure from the surface side. When the porous structure is formed, a resistance is increased, and when a portion of the porous structure is enlarged, the voltage increases in order to maintain the constant current. Therefore, it is preferable to provide a voltage monitoring device and monitor the voltage during recycled aluminum manufacture.

### <Step of Recovering Aluminum Precipitate>

Step 104 of recovering an aluminum precipitate is a step of recovering the aluminum precipitate deposited on the cathode in the solid electrolysis step.

As a method for recovering the aluminum precipitate deposited on the cathode, a known method can be used. For example, the aluminum precipitate is mechanically scraped off, or when the cathode is aluminum or an aluminum alloy-based cathode, the cathode can be melted together with the aluminum precipitate to be used for alloy applications that can be used industrially.

### <Step of Dissolving Recovered Aluminum Precipitate>

Step 105 of dissolving the recovered aluminum precipitate is a step of dissolving the aluminum precipitate recovered in the step of recovering the aluminum precipitate.

The step of dissolving the aluminum precipitate can be performed, for example, by the same method as the step of melting the aluminum alloy scrap.

A recycled aluminum alloy material having a desired concentration also can be manufactured by adding the alloy components.

In addition, according to the method for manufacturing recycled aluminum of the invention, aluminum alloy elements such as silicon (Si) and copper (Cu) contained in a large amount in an aluminum cast material scrap or the like can be significantly removed, and high-purity aluminum can be recycled or recovered. In Example 1, the purity of aluminum was 99.9%, and in Example 2, the purity thereof was 99.88%. In the invention, the concentration of silicon (Si) can be reduced to a range of, for example, 1000 ppm to 10 ppm. In addition, processed aluminum products having various shapes and sizes can be obtained from such recycled aluminum of the invention by a known processing technique.

### <Step of Producing Recycled Aluminum>

Step 106 of producing recycled aluminum is a step of collecting the aluminum precipitate dissolved in the step of dissolving the recovered aluminum precipitate as, for example, an aluminum ingot.

### <Others>

As the solid electrolysis progresses, as illustrated in FIG. 2, the aluminum alloy anodes become a porous structure from the surface side, but the aluminum alloy having the original compositions remains on a core side of the aluminum alloy anodes. Therefore, after the manufacture of recycled aluminum or during the manufacture of recycled aluminum, the aluminum alloy anodes may be taken out, and the core side thereof may be used as a raw material for producing the aluminum alloy anode.

In addition, an electrolytic residue having the porous structure formed on the surface side of the aluminum alloy anodes can be used as a raw material for manufacturing any impurity metal (for example, copper) contained in the electrolytic residue.

### [Recycled Aluminum]

The recycled aluminum according to the invention is manufactured by the method for manufacturing recycled aluminum described above.

As compared with the aluminum alloy material used for the anode as the raw material, the recycled aluminum is aluminum having reduced concentrations of the impurities. The concentration of the impurity Si in the recycled aluminum may be, for example, 0.001 mass % to 1 mass %, 0.001 mass % to 0.5 mass %, or 0.001 mass % to 0.1 mass %. Further, the concentration of the impurity Cu in the recycled aluminum may be, for example, 0.001 mass % to 0.5 mass %, 0.001 mass % to 0.2 mass %, or 0.001 mass % to 0.1 mass %.

### EXAMPLES

### Example 1

Each of potassium chloride (KCl, >99.5%) and lithium chloride (LiCl, >99.0%) was weighed and mixed sufficiently so as to have a eutectic composition (LiCl-41 mol % KCl). Thereafter, 5 mol % of aluminum fluoride (AlF₃) was added and mixed. The mixed LiCl—KCl-5 mol % AlF₃ was dried in an oven at 200° C. for 24 hours, and then was transferred to a graphite crucible and dried at 300° C. for 2 hours in a vacuum state. Thereafter, the temperature was increased to 550° C. in an Ar atmosphere and was maintained for 1 hour, and the molten salt was dissolved to have a uniform composition, and was used as an electrolytic bath.

In an electrolysis step, about 300 g of the pre-dissolved molten salt for the electrolytic bath was weighed and added to the graphite crucible, and was heated to 500° C. and maintained in an Ar atmosphere. A general-purpose aluminum die casting alloy AD12.1 plate (see (b) of FIG. 7) was used as an anode, and an aluminum plate was used as a cathode. As illustrated in FIG. 5, in order to stably perform the electrolysis, one anode was disposed at the center, and two cathodes were disposed to face both sides of the anode.

Electrolysis was performed for 2 hours with a current density of the anode set to 200 mA cm⁻², and a current density of the cathodes set to 100 mA cm⁻².

The compositions of the anode used are shown in Table 2.

TABLE 2

| | | | | | Other |
|---|---|---|---|---|---|
| | | Al | Si | Cu | components |
| Example 1 | AD12.1 alloy (anode) | 84.36 | 11.48 | 1.91 | 2.2 |
| | Recycled aluminum | 99.90 | 0.005 | 0.002 | 0.07 |
| | deposited on cathode | | | | |
| Example 2 | AC2A alloy (anode) | 90.18 | 5.05 | 3.75 | 1.0 |
| | Recycled aluminum | 99.88 | 0.01 | 0.005 | 0.1 |
| | deposited on cathode | | | | |

(The unit is mass %.)

An anode potential and a cathode potential during the electrolysis step were stable, and a cell voltage was 0.35 V. In particular, the stability of the anode potential and the cathode potential was confirmed via an electrochemical experiment by general cyclic voltammetry (CV). FIG. 10 illustrates a cyclic voltammogram curve of aluminum deposited on the cathode, which shows an ideal redox oxidation-reduction wave of aluminum. In addition, with respect to the potential in FIG. 8, an equilibrium potential for chlorine generation was measured using the same Ag/AgCl reference electrode, and the potential of the used Ag/AgCl reference electrode was −1.18 V (vs. Cl₂/Cl⁻), and thus a CV potential was illustrated in terms of reference potential (Cl₂/Cl⁻) based on the equilibrium potential for chlorine generation. As described above, under the molten salt of LiCl—KCl-0.5 mol % AlF₃ (T=400° C.), no redox reaction of the impurity elements was detected from aluminum deposited on the cathode, and the aluminum deposited on the cathode showed an ideal Nernstian response of aluminum.

After the electrolysis step, the anode and the cathodes were taken out, and the compositions were analyzed using fluorescence X-ray analysis (XRF). Results thereof are illustrated in (a) of FIG. 7. Substantially pure aluminum was deposited on the cathodes, and Si or the like in the AD12.1 alloy used as the anode remained as anode slime. The aluminum precipitate ((c) of FIG. 7) separated from the cathodes was redissolved and collected as ingots ((d) of FIG. 7).

Regarding results of composition analysis with respect to the obtained ingot (recycled aluminum), as shown in Table 2, the aluminum purity was 99.9%, the concentration of Si was about 0.005%, and the concentration of Cu was about 0.002%. In addition, the yield of aluminum before and after the electrolysis step was 95.6%, and a very small part of aluminum was moved into the anode slime (see (e) of FIG. 7).

### Example 2

The preparation of the electrolytic bath and an electrolysis experiment were carried out in the same manner as in Example 1.

A typical aluminum casting alloy AC2A was used as an anode. Similarly, a pure aluminum plate was used as a cathode. Electrolysis was performed for 2 hours with a current density of the anode set to 200 mA cm⁻², and a current density of the cathodes set to 100 mA cm⁻².

Compositions of the aluminum casting alloy AC2A used as the anode is also shown in Table 2.

An anode potential and a cathode potential during the electrolysis step were stable, and a cell voltage was about 0.3 V. After the electrolysis step, the anode and the cathode were taken out, and the compositions were analyzed using XRF. Results thereof are also shown in Table 2. Substantially pure aluminum was deposited on the cathode. An anode slime after the electrolysis step was collected and the components were identified by XRD. Results thereof are illustrated in FIG. 9. According to the results of XRD analysis, it was found that the anode slime remained after the electrolysis step was mainly composed of Si and Al₂Cu, and Al as a main component of the aluminum casting alloy AC2A was substantially completely dissolved.

### REFERENCE SIGNS LIST

1, 11 aluminum alloy anode
2 anode holder
3, 13 cathode
4, 14 molten salt
5, 15 electrolytic cell
6 heating device
7 power supply
10 solid electrolysis device

1. A method for manufacturing recycled aluminum, comprising:
disposing an aluminum alloy anode and a cathode in a molten salt in a facing manner;
supplying a current between the aluminum alloy anode and the cathode at a temperature at which the aluminum alloy anode is in a solid state and the molten salt is in a liquid state to ionize and elute aluminum from the aluminum alloy anode; and
depositing an aluminum precipitate on the cathode.

2. The method for manufacturing recycled aluminum according to claim 1, wherein
the aluminum alloy anode and the cathode have a flat plate shape, and
the flat plate-shaped aluminum alloy anode and the flat plate-shaped cathode are disposed in a facing manner, or alternatively, the cathode has a rod shape, and a plate-shaped aluminum alloy anode disposed concentrically around the rod-shaped cathode face the cathode.

3. The method for manufacturing recycled aluminum according to claim 1, further comprising:
precipitating anode mud (anode slime) containing an impurity element that is not ionized from the aluminum alloy anode.

4. The method for manufacturing recycled aluminum according to claim 1, wherein
the aluminum alloy anode is manufactured by a method including an anode producing step of dissolving an aluminum alloy scrap to produce an anode.

5. The method for manufacturing recycled aluminum according to claim 1, wherein
a conductivity of the molten salt is 1 S m⁻¹ or more.

6. The method for manufacturing recycled aluminum according to claim 1, wherein
the temperature is room temperature or higher and 660° C. or lower.

7. The method for manufacturing recycled aluminum according to claim 1, wherein
the molten salt contains AlF₃ in an amount of 1.5 mass % to 35 mass %.

8. The method for manufacturing recycled aluminum according to claim 3, further comprising:
taking out the precipitated anode mud.

9. The method for manufacturing recycled aluminum according to claim 1, wherein
a direction in which the aluminum alloy anode and the cathode are disposed in a facing manner is substantially the same as a direction of gravity.

10. A manufacturing apparatus of recycled aluminum comprising:
a unit configured to dispose an aluminum alloy anode and a cathode in a facing manner in a molten salt, and supply a current between the aluminum alloy anode and the cathode at a temperature at which the aluminum alloy anode is in a solid state and the molten salt is in a liquid state, wherein
the manufacturing apparatus of recycled aluminum is configured to ionize aluminum from the aluminum alloy anode and deposit aluminum on the cathode, and is configured to precipitate anode mud (anode slime) containing an impurity element which is not ionized from the aluminum alloy anode.

11. The manufacturing apparatus of recycled aluminum according to claim 10, wherein
a plurality of anodes and cathodes in which the aluminum alloy anode and the cathode are disposed in a facing manner are disposed in the molten salt.

12. The manufacturing apparatus of recycled aluminum according to claim 11, further comprising:
a unit configured to wire the plurality of anodes and cathodes in which the aluminum alloy anode and the cathode are disposed in a facing manner, and supply a current thereto in parallel or in series.

13. A manufacturing system of recycled aluminum operable by wiring a plurality of the manufacturing apparatuses of recycled aluminum according to claim 12 serving as a single system.

14. Recycled aluminum manufactured by the method for manufacturing recycled aluminum according to claim 1.

15. The recycled aluminum according to claim 14, wherein
the recycled aluminum has a concentration of Si of 0.001 mass % or more and 1 mass % or less, and a concentration of Cu of 0.001 mass % or more and 0.5 mass % or less.

16. A processed aluminum product obtained by processing the recycled aluminum according to claim 14.

17. An anode slime obtained by manufacturing recycled aluminum using the method for manufacturing recycled aluminum according to claim 1.
